(19) United States
(12) Patent Application Publication
(10) Pub. No.: US 2025/0385251 A1
(43) Pub. Date: Dec. 18, 2025

(54) NEGATIVE ELECTRODE FOR RECHARGEABLE LITHIUM BATTERY AND RECHARGEABLE LITHIUM BATTERY

(71) Applicant: SAMSUNG SDI CO., LTD., Yongin-si (KR)

(72) Inventors: Junkyu LEE, Yongin-si (KR); Kwanghwan CHO, Yongin-si (KR); Wonhyung CHAE, Yongin-si (KR); Mingu CHOI, Yongin-si (KR); Kyunghwa JUNG, Yongin-si (KR); Keewook KIM, Yongin-si (KR); Eunhee IM, Yongin-si (KR)

(73) Assignee: SAMSUNG SDI CO., LTD., Yongin-si (KR)

(21) Appl. No.: 19/035,464

(22) Filed: Jan. 23, 2025

(30) Foreign Application Priority Data
Jun. 13, 2024 (KR) 10-2024-0077033

(51) Int. Cl. H01M 4/36; H01M 4/02; H01M 4/133; H01M 4/134; H01M 4/38; H01M 4/583; H01M 4/62; H01M 10/0525

(52) U.S. Cl. CPC H01M 4/366; H01M 4/133; H01M 4/134; H01M 4/364; H01M 4/386; H01M 4/583; H01M 4/622; H01M 4/625; H01M 10/0525; H01M 2004/021; H01M 2004/027

(57) ABSTRACT

Disclosed are negative electrodes and rechargeable lithium batteries. The negative electrode includes a negative electrode current collector, and a negative electrode active material layer on the negative electrode current collector. The negative electrode active material layer includes a first negative electrode active material that includes a silicon-carbon composite, a second negative electrode active material that includes a first carbon-based material having a degree of divergence (DD) value that is equal to or greater than about 15, a binder, and a conductive material that includes a second carbon-based material having a one-dimensional nano-structure.

### CROSS-REFERENCE TO RELATED APPLICATION

This U.S. nonprovisional application claims priority under 35 U.S.C § 119 to Korean Patent Application No. 10-2024-0077033 filed on Jun. 13, 2024 in the Korean Intellectual Property Office, the disclosure of which is hereby incorporated by reference in its entirety.

### BACKGROUND

The present disclosure relates to a negative electrode for a rechargeable lithium battery, and a rechargeable lithium battery including the negative electrode.

With increasing availability of battery-using electronic devices, such as, e.g., mobile phones, laptop computers, and electric vehicles, there is increasing demand for rechargeable batteries with high energy density and high capacity.

A rechargeable lithium battery typically includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

An example embodiment of the present disclosure includes an economical negative electrode containing a high amount of silicon and having low expansion rate and a rechargeable lithium battery including the same.

An example embodiment of the present disclosure includes a negative electrode capable of predicting an amount of conductive material appropriate for a structure thereof, and a rechargeable lithium battery including the same.

According to an example embodiment of the present disclosure, a negative electrode for a rechargeable lithium battery may include a negative electrode current collector, and a negative electrode active material layer on the negative electrode current collector. The negative electrode active material layer may include a first negative electrode active material that includes a silicon-carbon composite, a second negative electrode active material that includes a first carbon-based material having a degree of divergence (DD) value of equal to or greater than about 15, the DD value being defined by Equation 1 below, a binder, and a conductive material that includes a second carbon-based material having a one-dimensional nano-structure.

$$DD ( degree of divergence ) = ( {I}_{a} / {I}_{total} ) \times 100 \qquad Equation 1$$

In Equation 1, Iₐ may be a sum of intensities of peaks at non-planar angles in an x-ray diffraction (XRD) measurement using CuK α radiation, and Iₜₒₜₐₗ may be a sum of intensities of all peaks in the XRD measurement using CuK α radiation.

According to an example embodiment of the present disclosure, a negative electrode for a rechargeable lithium battery may include a negative electrode current collector, and a negative electrode active material layer on the negative electrode current collector. The negative electrode active material layer may include a first negative electrode active material that includes a silicon-carbon composite, and a second negative electrode active material that includes a first carbon-based material having a degree of divergence (DD) value of equal to or greater than about 15, the DD value being defined by Equation 1 above. A ratio of an amount of the first negative electrode active material to an amount of the second negative electrode active material may be in a range of about 2 wt % to about 80 wt %.

According to an example embodiment of the present disclosure, a rechargeable lithium battery may include a positive electrode that includes a positive electrode current collector, and a positive electrode active material layer on the positive electrode current collector, the negative electrode for the rechargeable lithium battery mentioned above, and a separator between the positive electrode and the negative electrode.

### BRIEF DESCRIPTION OF DRAWINGS

FIG. 1 is a simplified conceptual diagram illustrating a rechargeable lithium battery according to an example embodiment of the present disclosure.

FIGS. 2 to 5 are simplified diagrams illustrating a rechargeable lithium battery according to an example embodiment, with FIG. 2 illustrating a cylindrical battery, FIG. 3 illustrating a prismatic battery, and FIGS. 4 and 5 illustrating pouch-type batteries.

FIG. 6 is a cross-sectional view illustrating a negative electrode for a rechargeable lithium battery according to an example embodiment of the present disclosure.

FIG. 7 is an enlarged view illustrating a negative electrode active material layer according to an example embodiment of the present disclosure.

FIG. 8 is a diagram illustrating a first negative electrode active material according to an example embodiment of the present disclosure.

FIG. 9 is a diagram illustrating a first negative electrode active material according to an example embodiment of the present disclosure.

FIG. 10 is a diagram illustrating a second negative electrode active material according to an example embodiment of the present disclosure.

FIGS. 11 and 12 are graphs illustrating a relation of full-charge expansion rate, amount of conductive material, and a cycle life of a rechargeable lithium battery, according to fabrication examples of the present disclosure.

### DETAILED DESCRIPTION

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element or intervening elements may be present between therebetween. In the drawings, thicknesses of some components may be exaggerated for effectively explaining the technical contents. Like reference numerals refer to like elements throughout the specification.

Some example embodiments detailed in this description will be discussed with reference to sectional and/or plan views as ideal exemplary views of the present disclosure. In the drawings, thicknesses of layers and regions may be exaggerated for effectively explaining the technical contents. Accordingly, regions exemplarily illustrated in the drawings have general properties, and shapes of regions exemplarily illustrated in the drawings exemplarily disclose specific shapes but not limited to the scope of the present disclosure. It will be understood that, although the terms “first”, “second”, “third,” etc. may be used herein to describe various elements, these elements should not be limited by these terms. These terms are only used to distinguish one element from another element. The example embodiments explained and illustrated herein include complementary example embodiments thereof.

The terminology used herein is for the purpose of describing particular example embodiments only and is not intended to limit the present disclosure. As used herein, the singular forms are intended to include the plural forms as well. The terms ‘comprises/includes’ and/or ‘comprising/including’ used in the specification do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

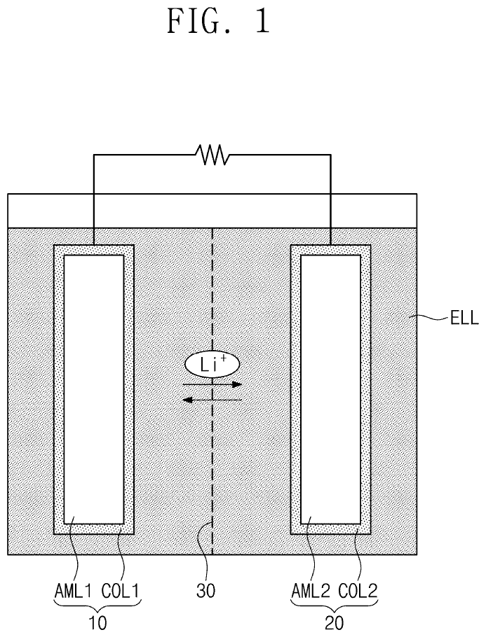

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that can be a sacrificial positive electrode.

An amount of the positive electrode active material in the positive electrode active material layer AML1 may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may be configured to improve attachment of positive electrode active material particles to each other, and also to improve attachment of the positive electrode active material to the current collector COLL. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause a chemical change in a battery may be the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included in the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O₄₋ₑD_{c} (where 0.90≤a≤1.8, 0≤b≤0.5, and 0≤c≤0.05); LiₐNi_{1-b c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity, and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may be configured to improve attachment of negative electrode active material particles to each other, and also to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be configured to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x≤2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be used in combination with a carbon-based negative electrode active material.

### Separator 30

Based on the type of the rechargeable lithium battery, the separator 30 may be located between the positive electrode 10 and the negative electrode 20. The separator 30 may include one or more of polyethylene, polypropylene, and polyvinylidene fluoride, and may have a multi-layered separator thereof such as or including at least one of a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one or opposite surfaces of the porous substrate, the coating layer including an organic material, an inorganic material, or a combination thereof.

The porous substrate may be or include a polymer layer including at least one of a polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be or include a material that is dissolved in the non-aqueous organic solvent to constitute a supply source of lithium ions in a battery, and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

### Rechargeable Lithium Battery

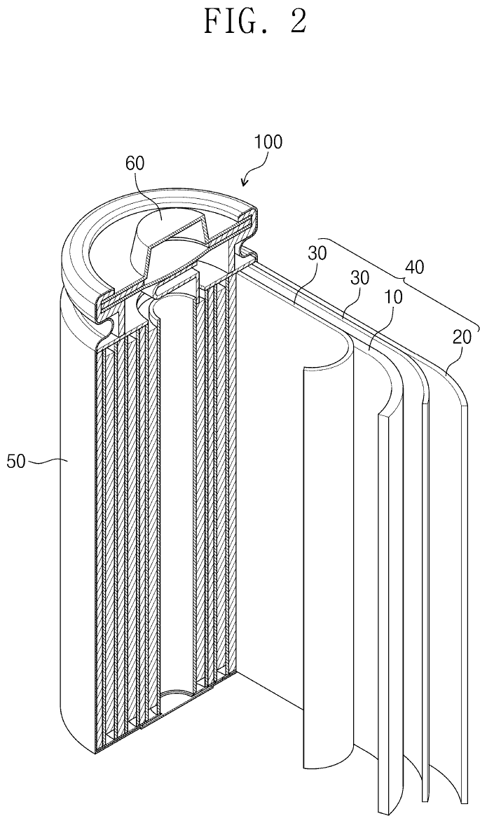

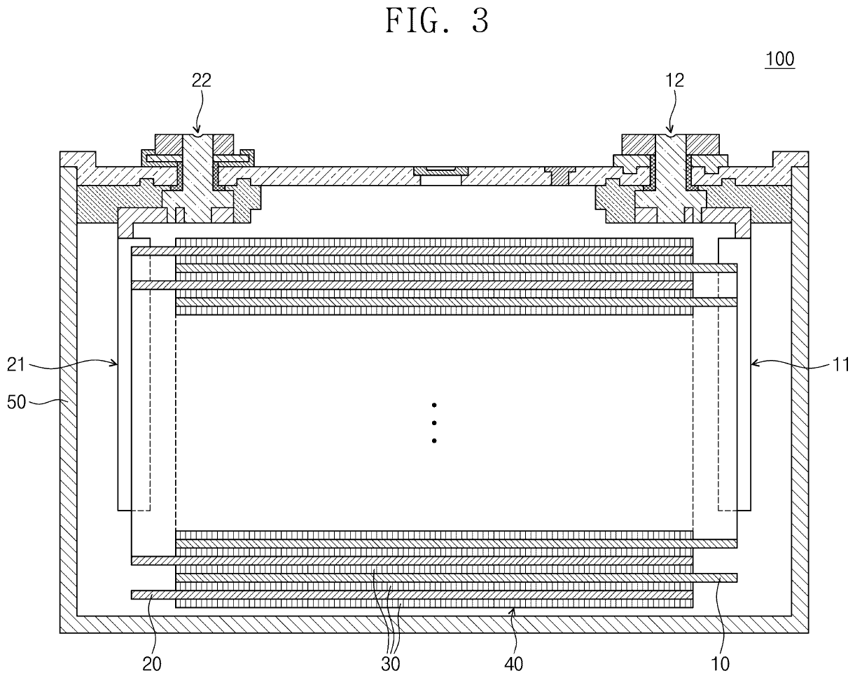

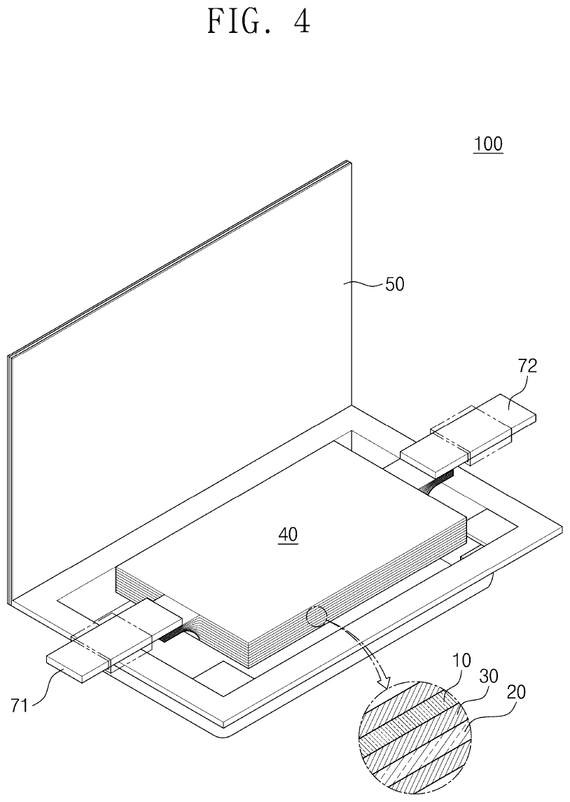

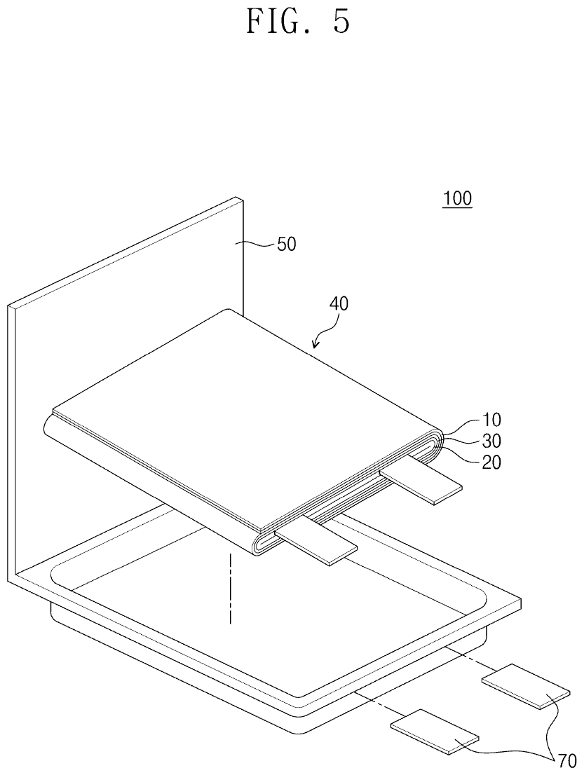

Based on the shape of the rechargeable lithium battery, the rechargeable lithium battery may be classified into cylindrical, prismatic, pouch, and coin types. FIGS. 2 to 5 are simplified diagrams illustrating a rechargeable lithium battery according to an example embodiment, with FIG. 2 illustrating a cylindrical battery, FIG. 3 illustrating a prismatic battery, and FIGS. 4 and 5 illustrating pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50, as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, with electrode tabs 70/71/72 forming an electrical path for externally inducing a current generated in the electrode assembly 40 to the outside of the battery 100.

The rechargeable lithium battery according to an example embodiment of the present disclosure may be applicable to, e.g., automotive vehicles, mobile phones, and/or any other electrical devices, but the present disclosure is not limited thereto.

The following description will focus on the negative electrode 20, according to some example embodiments of the present disclosure.

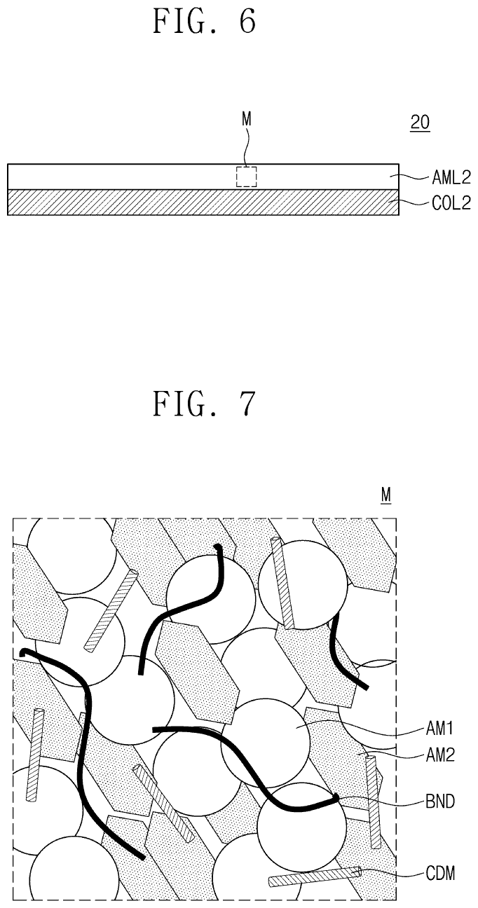

FIG. 6 illustrates a cross-sectional view showing the negative electrode 20 according to an example embodiment of the present disclosure.

Referring to FIG. 6, the negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material.

The negative electrode current collector COL2 may include at least one of a copper foil, a nickel foil, a stainless-steel foil, a titanium foil, a nickel foam, a copper foam, a polymer substrate coated with a conductive metal, or a combination thereof.

The negative electrode current collector COL2 may have a thickness of about 1 μm to about 20 μm. For example, the negative electrode current collector COL2 may have a thickness of about 5 μm to about 15 μm, about 7 μm to about 10 μm, or about 8 μm to about 10 μm.

### Negative Electrode Active Material Layer AML2

FIG. 7 illustrates an enlarged view of section M depicted in FIG. 6, illustrating the negative electrode active material layer AML2 according to an example embodiment of the present disclosure.

Referring to FIG. 7, the negative electrode active material layer AML2 may include a first negative electrode active material AM1, a second negative electrode active material AM2, a binder BND, and a conductive material CDM.

The first negative electrode active material AM1 may be included in an amount of about 2 wt % to about 40 wt % relative to the total weight of the negative electrode active material layer AML2. For example, the first negative electrode active material AM1 may be included in an amount of about 2 wt % to about 20 wt %, about 2 wt % to about 10 wt %, or about 4 wt % to about 10 wt % relative to the total weight of the negative electrode active material layer AML2.

The second negative electrode active material AM2 may be included in an amount of about 50 wt % to about 97.5 wt % relative to the total weight of the negative electrode active material layer AML2.

A ratio of the amount of the first negative electrode active material AM1 to the amount of the second negative electrode active material AM2 may be about 2% to about 80%. For example, a ratio of the amount of the first negative electrode active material AM1 to the amount of the second negative electrode active material AM2 may be about 2% to about 30%, about 2% to about 13%, or about 4% to about 13%.

When the first and second negative active materials AM1 and AM2 have their amount within any of the ranges above, the rechargeable lithium battery may exhibit increased capacity and energy density.

The binder BND may be included in an amount of about 0.5 wt % to about 5 wt % relative to the total weight of the negative electrode active material layer AML2. For example, the binder BND may be included in an amount of about 0.8 wt % to about 4 wt % or about 1 wt % to about 4 wt % relative to the total weight of the negative electrode active material layer AML2. When the binder BND is included in an amount within any of the ranges above, a negative electrode including a high amount of silicon may be hindered or prevented from excessively expanding during charge and discharge of the negative electrode.

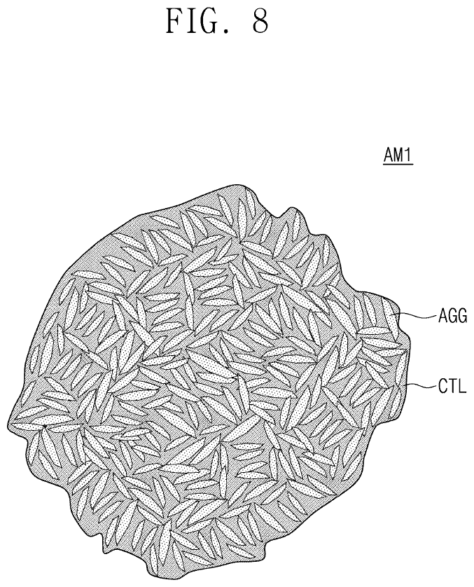

The first negative electrode active material AM1, the second negative electrode active material AM2, and the binder BND will be further discussed in detail with reference to FIGS. 8 to 10 below.

The conductive material CDM may be configured to provide an electrode with conductivity, and any suitable conductive material that does not cause chemical change in the battery may be included as the conductive material.

For example, the conductive material CDM may include a second carbon-based material. The second carbon-based material may have a one-dimensional nanostructure. The one-dimensional nanostructure may be defined to refer to a structure in which one of three dimensions, e.g., height, width and length, is larger than the other two dimensions.

The second carbon-based material may have a length of about 1 μm to about 50 μm. For example, the second carbon-based material may have a length of about 5 μm to about 20 μm.

The second carbon-based material may have an aspect ratio of about 10 to about 3,000. For example, the second carbon-based material may have an aspect ratio of about 10 to about 2,600, or about 20 to about 2,500, or about 30 to about 2,400. The aspect ratio may be calculated as a ratio of a length of the second carbon-based material to a diameter of the second carbon-based material.

When the second carbon-based material has its length and aspect ratio within any of the ranges above, negative electrode active materials may be connected to each other and may have a sufficient contact area therebetween. When the second carbon-based material has its length and aspect ratio within any of the ranges above, a sufficient contact area may be obtained between negative electrode active materials even when a negative electrode containing a high amount of silicon is charged and discharged. Therefore, an electrode plate may have an improved electrical conductivity, and a rechargeable lithium battery including the electrode plate may have an increased cycle life.

The second carbon-based material may include at least one of carbon nano-tubes, vapor-grown carbon fibers, single-walled carbon nano-tubes (SWCNT), and multi-walled carbon nano-tubes (MWCNT).

The conductive material CDM may be included in an amount of about 0 wt % to about 0.5 wt % relative to the total weight of the negative electrode active material layer AML2. For example, the conductive material CDM may be included in an amount of about 0.01 wt % to about 0.5 wt %, about 0.01 wt % to about 0.1 wt %, about 0.01 wt % to about 0.08 wt %, about 0.03 wt % to about 0.08 wt %, or about 0.04 wt % to about 0.08 wt % relative to the total weight of the negative electrode active material layer AML2. When the conductive material CDM is included in an amount within any of the ranges above, a sufficient contact area may be obtained between negative electrode active materials. Therefore, an electrode plate may have an improved electrical conductivity, and a rechargeable lithium battery including the electrode plate may have an increased cycle life.

### First Negative Electrode Active Material AM1

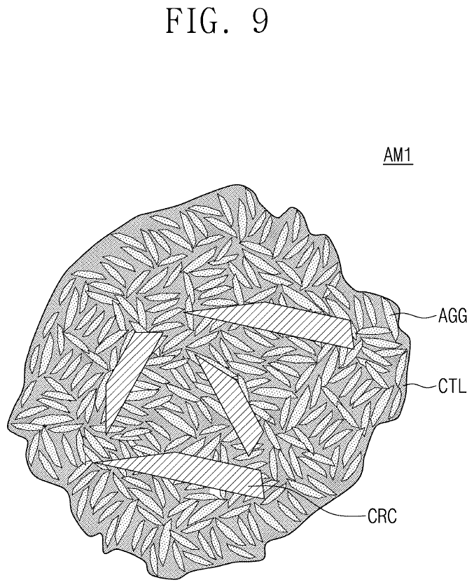

FIGS. 8 and 9 illustrate diagrams showing the first negative electrode active material AM1 according to an example embodiment of the present disclosure.

Referring to FIG. 8, the first negative electrode active material AM1 may include a silicon-carbon composite. The silicon-carbon composite may include an aggregate AGG and a coating layer CTL.

The aggregate AGG may be or include an agglomerate of a plurality of silicon particles. For example, one aggregate AGG may include a plurality of silicon particles that are agglomerated with each other. The aggregate AGG may have a spherical shape or an oval shape.

The aggregate AGG may have an average particle diameter of about 3 μm to about 20 μm. For example, in the present disclosure, an average particle diameter may be measured by a particle size analyzer. An average particle diameter may refer to a diameter of a particle at which a cumulative volume is about 50 vol % in a particle size distribution. When the aggregate AGG has an average particle diameter within the range above, it may be possible to achieve desired or advantageous high rate and cycle life characteristics.

For example, the plurality of silicon particles may include crystalline silicon. The crystalline silicon may improve a capacity and efficiency of a negative electrode active material.

For example, the plurality of silicon particles may include crystalline silicon, and a silicon oxide layer on a surface of the crystalline silicon. The silicon oxide layer may include SiO₂. The silicon oxide layer may have desired or advantageous mechanical strength and little reactivity with respect to an electrolyte.

There may be no limitation on a shape of the plurality of silicon particles. For example, a plurality of silicon particles may have a plate or spherical shape. For example, a plurality of silicon particles may have a flake shape.

The plurality of silicon particles may have an average particle diameter of about 10 nm to about 200 nm. For example, the plurality of silicon particles may each have a major axis and a minor axis. The major axis may be a width of the silicon particle, and the minor axis may be a thickness of the silicon particle. For example, the plurality of silicon particles may have an aspect ratio (a ratio of the major axis to the minor axis) of about 5 to about 20. When the plurality of silicon particles have an average particle diameter and an aspect ratio within the ranges above, it may be possible to substantially control a volume expansion of silicon during charge and discharge, and to reduce or prevent structural collapse.

An amount of silicon in the silicon-carbon composite may be about 40 wt % to about 55 wt % relative to the total weight of the first negative electrode active material AM1. For example, an amount of silicon in the silicon-carbon composite may be about 55 wt % relative to the total weight of the first negative electrode active material AM1.

Silicon in the silicon-carbon composite may be included in an amount of about 1 wt % to about 20 wt % relative to the total weight of the first negative electrode active material AM1 and the second negative electrode active material AM2. For example, silicon in the silicon-carbon composite may be included in an amount of about 1 wt % to about 10 wt %, about 1 wt % to about 5 wt %, or 2 wt % to about 5 wt % relative to the total weight of the first negative electrode active material AM1 and the second negative electrode active material AM2.

When silicon is included in an amount within any of the ranges above, a rechargeable lithium battery may be provided with desired or advantageous capacity, efficiency, and energy density.

The coating layer CTL may enclose the aggregate AGG. The coating layer CTL may include amorphous carbon. The amorphous carbon may enclose the aggregate AGG.

For example, the amorphous carbon may include at least one of non-graphitizable carbon (hard carbon) and graphitizable carbon (soft carbon). The amorphous carbon may have improved rigidity.

The coating layer CTL may have a D band (peak position at around 1350±50 cm⁻¹) and a G band (peak position at around 1580±50 cm⁻¹) in a Raman spectrum obtained by Raman spectroscopy. The coating layer CTL may have a D/G ratio that is equal to or greater than about 1.0. For example, the coating layer CTL may have a D/G ratio of about 1.0 to about 1.5.

For example, the coating layer CTL in the silicon-carbon composite may be distinguished based on component analysis or Raman analysis on negative electrode active materials.

The coating layer CTL may have a thickness of about 5 nm to about 50 nm. For example, the coating layer CTL may have a thickness of about 10 nm to about 20 nm. When the coating layer CTL has a thickness within any of the ranges above, the silicon-carbon composite may maintain its structure.

The coating layer CTL may further include a grain boundary coating layer that surrounds a surface of each of the plurality of silicon particles. The grain boundary coating layer may be present in an inner portion of the silicon-carbon composite. The grain boundary coating layer may be coated along an interface between the plurality of silicon particles. For example, the grain boundary coating layer may be or include a material coated at a grain boundary in the silicon-carbon composite. The grain boundary coating layer may include amorphous carbon.

The inner portion of the silicon-carbon composite may refer to an entire inside of the silicon-carbon composite, except for a surface of the silicon-carbon composite. For example, the inner portion of the silicon-carbon composite may indicate an entire inside from a depth of about 5 nm to about 50 nm from the surface of the silicon-carbon composite.

As the coating layer CTL further includes the grain boundary coating layer, the silicon-carbon composite may have reinforced structural stability and increased electrical conductivity.

The coating layer CTL may hinder or prevent the aggregate AGG and the plurality of silicon particles from being exposed to an electrolyte. The coating layer CTL may reduce or suppress volume expansion of the aggregate AGG and the plurality of silicon particles. In addition, the coating layer CTL may constitute an electron transport pathway between an electrolyte and amorphous carbon and the plurality of silicon particles, thereby providing a negative electrode which resistance is reduced, and electrical conductivity is thus increased.

Referring to FIG. 9, the silicon-carbon composite may further include crystalline carbon CRC. For example, the crystalline carbon CRC may include at least one of natural graphite and artificial graphite. For example, the crystalline carbon CRC may be or include at least one of natural graphite, artificial graphite, or a combination thereof. The crystalline carbon CRC may have high ductility and desired or advantageous electrical conductivity.

The crystalline carbon CRC may be included in an amount of about 2 wt % to about 7 wt % relative to the total amount of the silicon-carbon composite. For example, the crystalline carbon CRC may be included in an amount of about 5 wt % relative to the total amount of the silicon-carbon composite. When the crystalline carbon CRC is included in an amount within the range above, it may be possible to maintain a structure of the silicon-carbon composite and to provide a negative electrode which electrical conductivity is desired or advantageous. Accordingly, a rechargeable lithium battery may improve in output, capacity, efficiency, and cycle life.

### Second Negative Electrode Active Material AM2

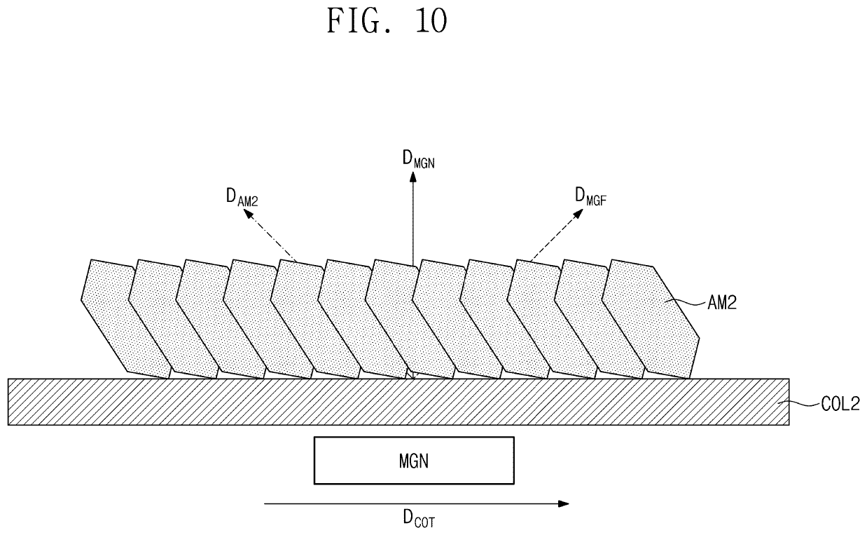

FIG. 10 is a diagram illustrating the second negative electrode active material AM2 according to an example embodiment of the present disclosure.

Referring to FIG. 10, the second negative electrode active material AM2 may include a first carbon-based material. For example, the first carbon-based material may be crystalline. A plurality of peaks may appear in an XRD spectrum of the first carbon-based material.

For example, in an XRD spectrum using CuK α radiation, the first carbon-based material may have a peak corresponding to a (002) plane, a peak corresponding to a (100) plane, a peak corresponding to a (101) R plane, a peak corresponding to a (101) H plane, a peak corresponding to a (004) plane, and a peak corresponding to a (110) plane. A maximum intensity of the peak corresponding to the (002) plane may appear at a diffraction angle (2θ) in a range of about 26.3° to about 26.7°. A maximum intensity of the peak corresponding to the (100) plane may appear at a diffraction angle (2θ) in a range of about 42.2° to about 42.6°. A maximum intensity of the peak corresponding to the (101) R plane may appear at a diffraction angle (2θ) in a range of about 43.2° to about 43.6°. A maximum intensity of the peak corresponding to the (101) H plane may appear at a diffraction angle (2θ) in a range of about 44.4° to about 44.8°. A maximum intensity of the peak corresponding to the (004) plane may appear at a diffraction angle (2θ) in a range of about 54.5° to about 54.9°. A maximum intensity of the peak corresponding to the (110) plane may appear at a diffraction angle (2θ) in a range of about 77.3° to about 77.7°.

For example, the XRD measurement may be performed under the condition of a diffraction angle (2θ) of about 10° to about 80°, a scan speed of about 0.044°/s to about 0.089°/s, and a step size of about 0.013°/step to about 0.039°/step.

The first carbon-based material may be oriented at a certain angle for facilitated transport of lithium ions in the negative electrode active material layer AML2. The first carbon-based material may have a degree of divergence (DD) value, which is defined by Equation 1 below, that is equal to or greater than about 15. For example, the first carbon-based material may have a DD value of about 15 to about 70, or of about 15 to about 60.

$$DD ( degree of divergence ) = ( {I}_{a} / {I}_{total} ) \times 100 \qquad Equation 1$$

In Equation 1, Iₐ may indicate a sum of intensities of peaks at non-planar angles in the X-ray diffraction (XRD) measurement using CuK α radiation. Iₜₒₜₐₗ may indicate a sum of intensities of all peaks appearing in the XRD measurement using CuK α radiation.

In the XRD spectrum using CuK α radiation, peaks appearing at non-planar angles may include the peak corresponding to the (100) plane, the peak corresponding to the (101) R plane, the peak corresponding to the (101) H plane, and the peak corresponding to the (110) plane. Graphite may be typically classified into a hexagonal structure and a rhombohedral structure having a stacking sequence of an “ABAB” shape in accordance with a stacking order of graphene layers. The R plane may refer to the rhombohedral structure, and the H plane may refer to the hexagonal shape.

In the XRD spectrum using CuK α radiation, all peaks appearing when XRD is measured may include the peak corresponding to the (002) plane, the peak corresponding to the (100) plane, the peak corresponding to the (101) R plane, the peak corresponding to the (101) H plane, and the peak corresponding to the (004) plane.

A sum of peak intensities as discussed herein may indicate a sum total of height values of each peak, or a sum total of integral area values of each peak. For example, a sum of peak intensities may refer to a sum total of integral area values of each peak.

The DD value of the first carbon-based material may be adjusted in fabricating a negative electrode. For example, the DD value of the first carbon-based material may be adjusted by placing a magnet MGN below the negative electrode current collector COL2, coating on the negative electrode current collector COL2 a negative electrode active material slurry including the first carbon-based material, exposing the slurry to a magnetic field D_{MGN}, and drying and pressing the slurry.

For example, a magnetic field D_{MGN} of the magnet MGN may have a strength of about 1,000 Gauss to about 10,000 Gauss. An exposure time to the magnetic field D_{MGN} may range from about 3 seconds to about 9 seconds.

The magnetic field D_{MGN} of the magnet MGN may be formed in a direction substantially perpendicular to the negative electrode current collector COL2. When a negative electrode active material slurry is coated on a surface of the negative electrode current collector COL2 during movement thereof, a magnetic field D_{M}GF may be formed at a given angle depending on a coating direction D_{COT} and a coating speed of the negative electrode active material slurry. Therefore, the first carbon-based material may stand, or be oriented at a given angle on the surface of the negative electrode current collector COL2 (D_{AM2}).

The DD value of the first carbon-based material may be maintained substantially even when charge and discharge are performed.

When the first carbon-based material has a DD value within the range above, it may be possible to provide a rechargeable lithium battery in which lithium ions readily move during charge and discharge, and which has improved resistance, rate characteristics, energy density, and cycle life.

### Binder BND

The binder BND may improve attachment of negative electrode active material particles to each other, and also to improve attachment of the negative electrode active material to the current collector COL2.

For example, the binder BND may include a first repeating unit and a second repeating unit.

The first repeating unit may be derived from a (meth)acrylic acid-based monomer. For example, the (meth)acrylic acid-based monomer may include at least one of (meth)acrylic acid, metal salt of (meth)acrylic acid, ammonium salt of (meth)acrylic acid, and amine salt of (meth)acrylic acid.

In this description, “(meth)” may or may not include a methyl group. For example, (meth)acrylate may refer to acrylate or methacrylate.

In the metal salt of (meth)acrylic acid, the metal may be or include alkali metal or alkaline earth metal. The metal may be or include, for example, at least one of lithium, sodium, potassium, calcium, or magnesium. For example, the metal salt of (meth)acrylic acid may include at least one of sodium acrylate, lithium acrylate, potassium acrylate, calcium acrylate, magnesium acrylate, sodium methacrylate, lithium methacrylate, potassium methacrylate, calcium methacrylate, or a combination thereof.

The ammonium salt of (meth)acrylic acid may be or include an ammonia neutralized product of (meth)acrylic acid.

The amine salt of (meth)acrylic acid may be or include at least one of a monoethanolamine neutralized product, a diethanolamine neutralized product, a hydroxylamine neutralized product, or a combination thereof.

For example, the first repeating unit may include at least one of a carboxyl group (—COOH), a metal salt of carboxylic acid, ammonium salt of carboxylic acid, amine salt of carboxylic acid, or a combination thereof. For example, after a polymerization reaction of (meth)acrylic acid, H⁺ of a carboxyl group derived from (meth)acrylic acid may be substituted with at least one of metal salt, ammonium salt, and amine salt to respectively form the metal salt of carboxylic acid, the ammonium salt of carboxylic acid, and the amine salt of carboxylic acid. Alternatively, the metal salt of carboxylic acid, the ammonium salt of carboxylic acid, and the amine salt of carboxylic acid may be formed by polymerizing a mixture of (meth)acrylic acid, metal salt of (meth)acrylic acid, ammonium salt of (meth)acrylic acid, and amine salt of (meth)acrylic acid.

The second repeating unit may be derived from a (meth)acrylonitrile-based monomer. For example, the (meth)acrylonitrile-based monomer may include (meth)acrylonitrile.

For example, the second repeating unit may include a cyano group.

The first repeating unit and the second repeating unit may have a weight ratio of about 35:65 to about 65:35. For example, the first repeating unit may be included in an amount of about 35 wt % to about 65 wt % relative to the total weight of the binder BND. For example, the second repeating unit may be included in an amount of about 35 wt % to about 65 wt % relative to the total weight of the binder BND. When the first repeating unit and the second repeating unit are included in amounts within the range above, a negative electrode including a high amount of silicon may be hindered or prevented from being excessively expanded during charge and discharge of the negative electrode.

Alternatively, the binder BND may further include a third repeating unit. For example, the binder BND may include the first repeating unit, the second repeating unit, and the third repeating unit.

The third repeating unit may be derived from a monomer that can copolymerize with (meth)acrylic acid-based monomer and the (meth)acrylonitrile-based monomer. The third repeating unit may be derived from a (meth)acrylamide-based monomer including a sulfonic acid group.

For example, the third repeating unit may include at least one of a sulfonic acid group (—SO₃H), a sulfonate ion (—SO₃—), a phosphonic acid group (—PO(OH)₂), a phosphonate ion (—PO(OH)O—), a phosphate ion (—PO₃²⁻), a phosphinic acid group (—P(O)H(OH)), or a phosphinate ion (—P(O)HO⁻).

As the binder BND further includes the third repeating unit, it may be possible to effectively reduce or prevent expansion of a negative electrode including a high amount of silicon.

A negative electrode active material layer, and a negative electrode including the negative electrode active material layer according to some example embodiments of the present disclosure may have the following characteristics.

A negative electrode active material layer according to some example embodiments of the present disclosure may include a high amount of silicon and reduce or prevent excessive expansion of a negative electrode during charge and discharge. In addition, a rechargeable lithium battery including the negative electrode active material layer may improve in capacity, efficiency, energy density, and cycle life.

Furthermore, during charge and discharge of a negative electrode according to some example embodiments of the present disclosure, an increase in the amount of silicon may cause further expansion of the negative electrode. During charge and discharge of a negative electrode according to some example embodiments of the present disclosure, a linear relationship may be provided between a full-charge expansion rate (x) of the negative electrode and an amount of silicon in the silicon-composite composite.

In a negative electrode according to some example embodiments of the present disclosure, the following Equation 2 may be satisfied between a full-charge expansion rate (x) of the negative electrode, an amount of a conductive material (y), and the number of cycles at SOH80 (z).

$$ax + by = z \qquad Equation 2$$

In Equation 2, a and b may be constants.

In this description, the full-charge expansion rate (x) of the negative electrode may be defined to refer to a ratio of the difference between an initial thickness of the negative electrode and a charge thickness of the negative electrode after charging and dissembling a rechargeable lithium battery to the initial thickness of the negative electrode, or Full-charge expansion rate (%)=[(charge thickness−initial thickness)/initial thickness]×100. The “x” in Equation 2 may range from about 25 to about 45. For example, the full-charge expansion rate may range from about 25% to about 45%. For example, the x in Equation 2 may range from about 27 to about 42 or from about 29 to about 42.

In this description, the number of cycles at SOH80 (z) may be defined to refer to the number of cycles when a capacity retention rate becomes 80%. The z in Equation 2 may be equal to or greater than about 360. For example, the z may be equal to or greater than 360 or equal to or greater than about 1,600. For example, the z may be equal to or less than about 1,800.

When the z has a specific value, the full-charge expansion rate (x) of the negative electrode and the amount of the conductive material (y) may satisfy Equation 3 below.

$$y = 0.0031 x - b \qquad Equation 3$$

For example, when the z is about 1,800, the full-charge expansion rate (x) of the negative electrode and the amount of the conductive material (y) may be represented by Equation 3-1 below.

$$y = 0.0031 x - 0.0005 \qquad Equation 3 - 1$$

To achieve a rechargeable lithium battery having a desired cycle life, a required amount of the conductive material CDM may be derived from the equations above. The derived amount of the conductive material CDM may be a minimum amount required to achieve the desired cycle life. It may thus be possible to provide an economical rechargeable lithium battery having a desired or advantageous lifecycle.

Herein, the present disclosure will be described in detail with reference to some example embodiments. The following example embodiments are provided for illustrative purpose only and are not to be construed to limit the scope of the present disclosure.

### Preparation 1: First Negative Electrode Active Material AM1 Including Silicon-Carbon Composite

A silicon-carbon composite containing silicon having an amount of about 50 wt % relative to the total weight of the silicon-carbon composite was prepared in the following manner.

Micro-sized silicon particles (average particle diameter: about 1 to 5 m) were ball-milled to prepare silicon particles having an average particle diameter of about 85 nm to about 100 nm. The silicon particles, stearic acid, and ethanol were mixed in a weight ratio of about 9:1:10 to prepare a dispersion solution. A spray dryer was used to spray-dry the dispersion solution at a temperature of about 120° C.

The spray-dried product and meso-carbon pitch were mixed in a weight ratio of about 50:20, and thermally treated at a temperature of about 900° C. to about 1,000° C. under the N₂ environment, thereby forming a coating layer including amorphous carbon.

### Preparation 2: Binder BND

Acrylic acid, acrylonitrile, and 2-allyloxy-2-hydroxy-1-propanesulfonic acid were mixed in a weight ratio of about 55:40:5 to prepare a binder monomer mixture. An azo compound initiator and water were added to the binder monomer mixture. The initiator was included in an amount of about 0.2 parts by weight relative to 100 parts by weight of the binder monomer mixture.

The obtained mixture was emulsion-polymerized to prepare a binder solution including a copolymer (weight average molecular weight: about 910,000 g/mol) having a first repeating unit derived from acrylic acid, a second repeating unit derived from acrylonitrile, and a third repeating unit derived from 2-allyloxy-2-hydroxy-1-propanesulfonic acid.

### Preparation 3: Negative Electrode

An example embodiment including a negative electrode current collector and a negative electrode active material layer, which negative electrode active material layer included a first negative electrode active material AM1, a second negative electrode active material AM2, a binder BND, and a conductive material CDM, were prepared. A DD value of graphite as the second negative electrode active material layer AM2 was equal to or greater than about 15. Preparation 3 was prepared in the following manner.

A slurry was prepared by mixing the first negative electrode active material AM1 of Preparation 1, graphite as the second negative electrode active material AM2, the binder solution of Preparation 2, a single-walled carbon nano-tube as the conductive material CDM, styrene-butadiene rubber, and distilled water. The styrene-butadiene rubber and the binder BND of Preparation 3 were added in an amount of about 1.5 wt % to about 2 wt relative to the total weight of the slurry.

A copper (Cu) foil was positioned above a magnet generating a magnetic field with strength of about 4,000 Gauss. The slurry was coated on the copper (Cu) foil during its movement. The copper (Cu) foil with the slurry coated thereon was exposed for about 9 seconds to the magnetic field. Afterwards, drying and pressing processes were performed to manufacture a negative electrode.

### Preparation 4: Rechargeable Lithium Battery

About 96 wt % of LiCoO₂, about 2 wt % of polyvinylidene fluoride (PVdF), and about 2 wt % of carbon black were mixed with N-methylpyrrolidone to prepare slurry, and the slurry was coated and dried on an aluminum (Al) foil and then pressed to manufacture a positive electrode.

The negative electrode, the positive electrode, a polyethylene separator, and an electrolyte were used to fabricate a rechargeable lithium battery. About 1.5M LiPF₆ was mixed in an organic solvent containing ethylene carbonate (EC), diethyl carbonate (DEC), and dimethyl carbonate (DMC) mixed in a volume ratio of about 2:1:7, and fluoroethylene carbonate (FEC) was added in an amount of about 3 parts by weight relative to 100 parts by weight of the organic solvent to obtain the electrolyte.

### Experimental Example 1: Analysis on Full-Charge Expansion Rate and Required Amount of Conductive Material

Analysis was performed on a full-charge expansion rate and an amount of the conductive material of the rechargeable lithium battery fabricated according to Preparation 4. The full-charge expansion rate of the negative electrode may be defined to refer to a ratio of the difference between an initial thickness of the negative electrode and a charge thickness of the negative electrode after charging and dissembling the rechargeable lithium battery to the initial thickness of the negative electrode, or Full-charge expansion rate (%)=[(charge thickness−initial thickness)/initial thickness]×100. The results are listed in Table 1 below.

TABLE 1

| | | | Full-charge | Required amount |
|---|---|---|---|---|
| | DD | Type of | expansion | of conductive |
| Silicon amount (wt %) | value | binder | rate (%) | material (wt %) |
| 2 wt % | <15 | CMC | 33.0 | 0.051 |
| (4 wt % of silicon-carbon | ≥15 | CMC | 33.0 | 0.041 |
| composite) | ≥15 | Fabrication 3 | 29.3 | 0.039 |
| 3 wt % | <15 | CMC | 37.0 | 0.063 |
| (6 wt % of silicon-carbon | ≥15 | CMC | 34.3 | 0.055 |
| composite) | ≥15 | Fabrication 3 | 33.2 | 0.051 |
| 4 wt % | <15 | CMC | 41.0 | 0.076 |
| (8 wt % of silicon-carbon | ≥15 | CMC | 38.6 | 0.069 |
| composite) | ≥15 | Fabrication 3 | 37.4 | 0.065 |
| 5 wt % | <15 | CMC | 46.0 | 0.092 |
| (10 wt % of silicon-carbon | ≥15 | CMC | 42.3 | 0.080 |
| composite) | ≥15 | Fabrication 3 | 41.0 | 0.076 |

Referring to Table 1, an increase in amount of silicon (or the silicon-carbon composite) caused further expansion of the rechargeable lithium battery. For example, there was a linear relationship between the silicon amount and the full-charge expansion rate.

As there were included the silicon-carbon composite (i.e., AM1) of Preparation 1, the graphite (i.e., AM2) having the DD value of about 15 or more, and the binder BND of Preparation 2, it was ascertained that it was possible to decrease the full-charge expansion rate and the required amount of the conductive material CDM.

### Experimental Example 2: Analysis on Relationship Between Full-Charge Expansion Rate, Amount of Conductive Material, and Cycle Life

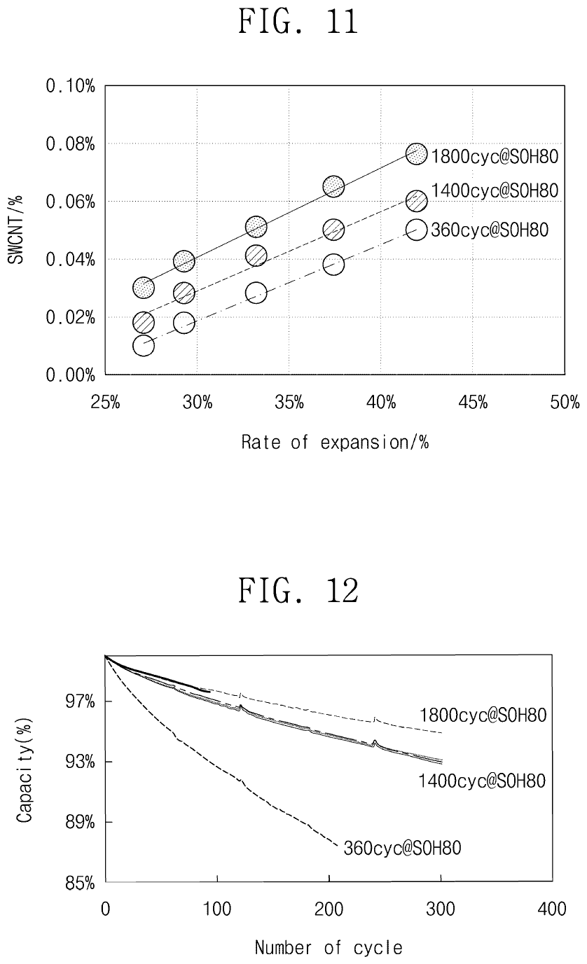

Table 2 below and FIG. 11 illustrate a relationship between a full-charge expansion rate, an amount of the conductive material, and an expected cycle life of the rechargeable lithium battery fabricated according to Preparation 4. The expected cycle life may be defined to refer to the number of cycles at SOH80. FIG. 12 shows results of cycle life of the recharge lithium battery fabricated according to Preparation 4. For example, when the silicon amount is about 4 wt %, FIG. 12 shows results of the cycle life of the rechargeable lithium batteries fabricated by adding amounts of the conductive materials listed in Table 2. Rechargeable lithium batteries were initially charged at a constant current (about 0.33 C), and after being rested for about 10 minutes, initially discharged at a constant current (about 0.5 C) until a voltage reached about 2.5 V, and this cycle was repeated under the same charge and discharge conditions to measure the cycle life.

TABLE 2

| | | | | | | Expected cycle life |
|---|---|---|---|---|---|---|
| Silicon amount | | | | | | (the number of |
| (wt %) | 1 wt % | 2 wt % | 3 wt % | 4 wt % | 5 wt % | cycles at SOH80) |
| Full-charge | 27.0 | 29.3 | 33.2 | 37.4 | 41.0 | |
| expansion rate (%) | | | | | | |
| Amount of | 0.03 | 0.04 | 0.05 | 0.07 | 0.08 | 1800 |
| conductive material | 0.02 | 0.03 | 0.04 | 0.05 | 0.06 | 1400 |
| (wt %) | 0.01 | 0.02 | 0.03 | 0.04 | 0.05 | 360 |

Referring to Table 2 and FIG. 11, Equation 2 below was satisfied between the full-charge expansion rate (x), the amount of the conductive material (y), and the expected cycle life (z).

$$a x + b y = z \qquad Equation 2$$

When the z had a specific value, the full-charge expansion rate (x) and the amount of the conductive material (y) satisfied Equation 3 below.

$$y = 0.0031 x - b \qquad Equation 3$$

It was observed that the cycle life of the rechargeable lithium battery can be changed by adjusting the amount of the conductive material in accordance with the full-charge expansion rate. For example, a variation in the amount of the conductive material can achieve the desired cycle life.

When the z was about 1,800, the b was about 0.0005. For example, when the z was about 1,800, the full-charge expansion rate (x) and the amount of the conductive material (y) satisfied Equation 3-1 below.

$$y = 0.0031 x - 0.0005 \qquad Equation 3 - 1$$

Referring to Table 2 and FIG. 12, it was observed that the cycle life of the rechargeable lithium battery was changed when the amount of the conductive material was varied at a specific amount of silicon (i.e., amount of silicon-carbon composite). Furthermore, it was ascertained that when rechargeable lithium batteries were fabricated with only varying amounts of silicon (or amounts of the silicon-carbon composite, for example, 3 wt % and the like), cycle life graphs of the rechargeable lithium batteries overlapped each other. Thus, it was confirmed that it was possible to predict an amount of the conductive material required for designing a rechargeable lithium battery containing a high amount of silicon and having a low-expansion structure.

A negative electrode, and a rechargeable lithium battery including the negative electrode according to an example embodiment of the present disclosure may improve in capacity, efficiency, energy density, and cycle life. In addition, according to an example embodiment of the present disclosure, a low amount of conductive material may be included to provide an economical negative electrode. and a rechargeable lithium battery including the negative electrode. Moreover, according to an example embodiment of the present disclosure, it may be possible to predict an amount of conductive material appropriate for a structure thereof.

Although some example embodiments of the present disclosure have been discussed with reference to accompanying figures, it will be understood that various changes in form and details may be made therein without departing from the spirit and scope of the present disclosure. It therefore will be understood that the example embodiments described above are just illustrative but not limitative in all aspects.

What is claimed is:

1. A negative electrode for a rechargeable lithium battery, the negative electrode comprising:
a negative electrode current collector; and
a negative electrode active material layer on the negative electrode current collector,
wherein the negative electrode active material layer includes:
a first negative electrode active material that includes a silicon-carbon composite;
a second negative electrode active material that includes a first carbon-based material having a degree of divergence (DD) value that is equal to or greater than about 15, the DD value being defined by Equation 1;
a binder; and
a conductive material that includes a second carbon-based material having a one-dimensional nano-structure,
$$DD ( degree of divergence ) = ( {I}_{a} / {I}_{total} ) \times 100 \qquad Equation 1$$
wherein, in Equation 1,
Iₐ is a sum of intensities of peaks at non-planar angles in an XRD measurement using CuK α radiation, and
Iₜₒₜₐₗ is a sum of intensities of all peaks in the XRD measurement using CuK α radiation.

2. The negative electrode of claim 1, wherein the silicon-carbon composite comprises:
an aggregate in which a plurality of silicon particles are agglomerated; and
a coating layer that surrounds the aggregate,
wherein the coating layer includes amorphous carbon.

3. The negative electrode of claim 2, wherein the silicon-carbon composite further comprises crystalline carbon.

4. The negative electrode of claim 1, wherein an amount of silicon in the silicon-carbon composite is in a range of about 1 wt % to about 20 wt % relative to a total weight of the first negative electrode active material and the second negative electrode active material.

5. The negative electrode of claim 1, wherein the peaks at non-planar angles include a peak corresponding to a (100) plane, a peak corresponding to a (101) R plane, a peak corresponding to a (101) H plane, and a peak corresponding to a (110) plane.

6. The negative electrode of claim 5, wherein:
a maximum intensity of the peak corresponding to the (100) plane appears at a diffraction angle (2θ) in a range of about 42.2° to about 42.6°,
a maximum intensity of the peak corresponding to the (101) R plane appears at a diffraction angle (2θ) in a range of about 43.2° to about 43.6°,
a maximum intensity of the peak corresponding to the (101) H plane appears at a diffraction angle (2θ) in a range of about 44.4° to about 44.8°, and
a maximum intensity of the peak corresponding to the (110) plane appears at a diffraction angle (2θ) in a range of about 77.3° to about 77.7°.

7. The negative electrode of claim 1, wherein the first carbon-based material comprises at least one of artificial graphite and natural graphite.

8. The negative electrode of claim 1, wherein the binder comprises:
a first repeating unit derived from a (meth)acrylic acid-based monomer; and
a second repeating unit derived from a (meth)acrylonitrile-based monomer.

9. The negative electrode of claim 8, wherein a weight ratio of the first repeating unit to the second repeating unit is in a range of about 35:65 to about 65:35.

10. The negative electrode of claim 8, wherein the binder further comprises a third repeating unit derived from a (meth)acrylamide-based monomer including a sulfonic acid group.

11. The negative electrode of claim 1, wherein an amount of the binder is in a range of about 0.8 wt % to about 4 wt % relative to a total weight of the negative electrode active material layer.

12. The negative electrode of claim 1, wherein an aspect ratio of the second carbon-based material is in a range of about 10 to about 3,000.

13. The negative electrode of claim 1, wherein the second carbon-based material includes at least one of carbon nano-tubes, vapor-grown carbon fibers, single-walled carbon nano-tubes, and multi-walled carbon nano-tubes.

14. The negative electrode of claim 1, wherein an amount of the conductive material is in a range of about 0.01 wt % to about 0.1 wt % relative to a total weight of the negative electrode active material layer.

15. The negative electrode of claim 1, wherein a thickness of the negative electrode current collector is in a range of about 1 m to about 20 m.

16. The negative electrode of claim 1, wherein there is a linear relationship between a full-charge expansion rate of the negative electrode and an amount of silicon in the silicon-composite.

17. The negative electrode of claim 1, wherein Equation 2 is satisfied between a full-charge expansion rate (x) of the negative electrode, an amount of the conductive material (y), and a number of cycles at SOH80,
$$ax + by = z \qquad Equation 2$$
wherein x is in a range of about 25 to about 45, and
wherein z is equal to or greater than about 360.

18. The negative electrode of claim 1, wherein Equation 3 is satisfied between a full-charge expansion rate (x) of the negative electrode and an amount of the conductive material (y),
$$y = 0.0031 x - 0.0005 \qquad Equation 3$$
wherein x is in a range of about 25 to about 45.

19. A negative electrode for a rechargeable lithium battery, the negative electrode comprising:
a negative electrode current collector; and
a negative electrode active material layer on the negative electrode current collector,
wherein the negative electrode active material layer includes:
a first negative electrode active material that includes a silicon-carbon composite; and
a second negative electrode active material that includes a first carbon-based material having a degree of divergence (DD) value that is equal to or greater than about 15, the DD value being defined by Equation 1,
wherein a ratio of an amount of the first negative electrode active material to an amount of the second negative electrode active material is in a range of about 2 wt % to about 80 wt %,
$$DD ( degree of divergence ) = ( {I}_{a} / {I}_{total} ) \times 100 \qquad Equation 1$$
wherein, in Equation 1,
Iₐ is a sum of intensities of peaks at non-planar angles in an XRD measurement using CuK α radiation, and
Iₜₒₜₐₗ is a sum of intensities of all peaks in the XRD measurement using CuK α radiation.

20. A rechargeable lithium battery, comprising:
a positive electrode that includes a positive electrode current collector and a positive electrode active material layer on the positive electrode current collector;
the negative electrode for the rechargeable lithium battery as set forth in claim 1; and
a separator between the positive electrode and the negative electrode.
